(19) United States
(12) Patent Application Publication
(10) Pub. No.: US 2015/0042298 A1
(43) Pub. Date: Feb. 12, 2015

(54) BUCK SWITCHING REGULATOR

(71) Applicants: Nien-Hui Kung, Hsinchu (TW); Chia-Hsiang Ling, Taipei (TW); Yu-Huei Lee, New Taipei (TW)

(72) Inventors: Nien-Hui Kung, Hsinchu (TW); Chia-Hsiang Ling, Taipei (TW); Yu-Huei Lee, New Taipei (TW)

(73) Assignee: RICHTEK TECHNOLOGY CORPORATION, Zhubei City (TW)

(21) Appl. No.: 14/246,060

(22) Filed: Apr. 5, 2014

(30) Foreign Application Priority Data
Aug. 7, 2013 (TW) 102214771

(51) Int. Cl. H02M 3/158

(52) U.S. Cl. CPC H02M 3/158
USPC 323/271

(57) ABSTRACT

The present invention discloses a buck switching regulator including a power stage, a driver circuit and a bootstrap capacitor. The power stage includes an upper-gate switch, a lower-gate switch and an inductor. The upper-gate switch is electrically connected between an input terminal and a switching node. The lower-gate switch is electrically connected between the switching node and ground. The bootstrap capacitor is electrically connected between a boost node and the switching node, wherein the boost node is electrically connected to a voltage supply. When a voltage across the bootstrap capacitor is smaller than a reference voltage, the lower-gate switch is turned on to charge the bootstrap capacitor from the voltage supply. When the charging operation to the bootstrap capacitor has been conducted over a predetermined time period or when the current of the inductor has reached a predetermined value, the charging operation to the bootstrap capacitor is ceased.

### CROSS REFERENCE

The present invention claims priority to TW 102214771, filed on Aug. 7, 2013.

### BACKGROUND OF THE INVENTION

1. Field of Invention

The present invention relates to a buck switching regulator; particularly, it relates to such buck switching regulator having improved power utilization efficiency.

2. Description of Related Art

FIG. 1 shows a schematic diagram of a conventional buck switching regulator. The conventional buck switching regulator 10 includes a power stage 11 which comprises an upper-gate switch MA, a lower-gate switch MB and an inductor L. The upper-gate switch MA, the lower-gate switch MB and the inductor L are electrically connected to a common switching node Lx and controlled by a driver circuit 12. In the driver circuit 12, an upper-gate driver circuit 121 and a lower-gate driver circuit 122 generate a first driving signal SA and a second driving signal SB according to a first operation signal S121 and a second operation signal 5122, respectively, to turn ON/OFF the upper-gate switch MA and the lower-gate switch MB, thus delivering power from an input terminal IN to an output terminal OUT (The rest of the driver circuit 12 is omitted for simplicity).

When the input voltage Vin is high, for better driving the upper-gate switch MA, the conventional buck switching regulator 10 usually includes a bootstrap capacitor CBOOT which is connected between the voltage supply Vdd in the driver circuit 12 and the source of the upper-gate switch MA (as shown in FIG. 1), i.e., between the boost node VBOOT and the switching node Lx, to provide a desired voltage difference between the gate and the source of the upper-gate switch MA. The voltage Vcap across the bootstrap capacitor CBOOT serves to provide an operational voltage to the upper-gate driver circuit 121. When the lower-gate switch MB is ON, the voltage supply Vdd in the driver circuit 12 charges the bootstrap capacitor CBOOT through a diode 13, so that when the lower-gate switch MB is OFF, the voltage at the boost node VBOOT becomes Vcap+VLx (wherein VLx is the voltage at the switching node Lx). Thus, the difference between the voltage at the boost node VBOOT (Vcap+VLx) and the voltage at the switching node Lx (VLx) becomes Vcap, to provide a sufficient driving voltage which is required by the upper-gate driver circuit 121. The diode 13 serves to prevent a reverse current from flowing from the boost node VBOOT toward the voltage supply Vdd when the voltage at the boost node VBOOT is higher than the voltage supply Vdd, so that there will not be such reverse current which may possibly damage the voltage supply Vdd. The output terminal OUT can be electrically connected to a system load 16 or a battery (not shown). When the system load 16 is consuming power (i.e., when the buck switching regulator 10 is required to supply power to the system load 16), the upper-gate switch MA and the lower-gate switch MB continue switching to deliver power from the input terminal IN to the output terminal OUT, and further to the system load 16. Hence, the bootstrap capacitor CBOOT will be routinely charged and refreshed so that the voltage Vcap across the bootstrap capacitor CBOOT will be kept at a desired level.

Nevertheless, when the system load 16 is in a stand-by mode (i.e., when the system load 16 consumes no or little power), both the upper-gate switch MA and the lower-gate switch MB are turned OFF since there is no need to deliver power from the input terminal IN to the output terminal OUT. Under such circumstance, the bootstrap capacitor CBOOT will not be charged and refreshed, and the charges stored in the bootstrap capacitor CBOOT will dissipate so that the voltage Vcap across the bootstrap capacitor CBOOT will drop gradually. At a certain time point, when the system load 16 resumes its normal operation, the buck switching regulator 10 is again required to supply the power. However, due to insufficient voltage Vcap across the bootstrap capacitor CBOOT, the voltage at the boost node VBOOT is insufficient, so the upper-gate driver circuit 121 does not have a sufficient driving capability to drive the upper-gate switch MA. As a result, when the conventional buck switching regulator 10 restores operation, it is required to charge the bootstrap capacitor CBOOT first. The way for charging the bootstrap capacitor CBOOT is to turn ON the lower-gate switch MB first so that the switching node Lx is electrically connected to ground, whereby the voltage supply Vdd can charge the bootstrap capacitor CBOOT through the diode 13.

Please refer to FIG. 2, which explains how the conventional buck switching regulator 10 unnecessarily consumes power. As described above, during the transition from stand-by to normal operation, it is required to turn ON the lower-gate switch MB first (during the period from the time point “Restore Operation” to the time point T1, i.e., the ON-time of the lower-gate switch MB is ATB, as shown in FIG. 2), so a reverse current will flow in a direction from the output terminal OUT to the lower-gate switch MB. Next, during the period from the time point T1 to the time point T2, when the upper-gate switch MA is turned ON and the lower-gate switch MB is turned OFF, a reverse current will flow in a direction from the output terminal OUT to the upper-gate switch MA. By the above operation, power will be delivered from the output terminal OUT, and a longer time period ATB will cause more unnecessarily waste of power. Furthermore, if such reverse power transmission is not properly controlled, it will result in a boost operation from the output terminal OUT to the input terminal IN. In addition, if the output terminal OUT is connected to a battery (not shown), the battery will keep discharging, which is also undesired.

In order to overcome the above-mentioned drawbacks, U.S. Pat. No. 7,235,955 proposes a solution, but its control mechanism is complicated.

In view of the above, to overcome the drawbacks in the prior art, the present invention proposes a buck switching regulator having improved power utilization efficiency.

### SUMMARY OF THE INVENTION

From one perspective, the present invention provides a buck switching regulator for converting an input voltage supplied from an input terminal to an output voltage at an output terminal, comprising: (1) a power stage, including: an upper-gate switch having one end electrically connected to the input terminal and another end electrically connected to a switching node; a lower-gate switch having one end electrically connected to the switching node and another end electrically connected to ground; and an inductor having one end electrically connected to the switching node and another end electrically connected to the output terminal; (2) a bootstrap capacitor, which is electrically connected between a boost node and the switching node, wherein the boost node is electrically connected to a voltage supply; and (3) a driver circuit for controlling the operation of the upper-gate switch and the lower-gate switch, the driver circuit including: a control signal generation circuit for generating a control signal to determine ON-time of the upper-gate switch and ON-time of the lower-gate switch; and a bootstrap capacitor charging control circuit coupled to the control signal generation circuit, for determining whether a voltage across the bootstrap capacitor is smaller than a reference voltage and generating an output signal accordingly, wherein when the voltage across the bootstrap capacitor is smaller than the reference voltage, the control signal generation circuit turns ON the lower-gate switch to charge the bootstrap capacitor from the voltage supply according to the output signal from the bootstrap capacitor charging control circuit.

In one embodiment, the bootstrap capacitor charging control circuit determines whether a time period during which the voltage across the bootstrap capacitor is smaller than the reference voltage has been over a predetermined period of time, and when it is determined yes, the output signal from the bootstrap capacitor charging control circuit causes the control signal generation circuit to turn Off the lower-gate switch.

In one embodiment, the bootstrap capacitor charging control circuit includes: a comparison circuit for comparing the voltage across the bootstrap capacitor with the reference voltage to generate a comparison output signal; an ON-time timer, wherein the ON-time timer starts to count a predetermined period of time when the comparison output signal indicates that the voltage across the bootstrap capacitor is smaller than the reference voltage, and when the predetermined period of time has been reached, the ON-time timer generates a time-out signal; and a latch for receiving the comparison output signal and the time-out signal as a set signal and a reset signal.

In one embodiment, the bootstrap capacitor charging control circuit determines whether a current of the inductor reaches a reference current level, and when it is determined yes, the output signal from the bootstrap capacitor charging control circuit causes the control signal generation circuit to turn Off the lower-gate switch.

In one embodiment, the bootstrap capacitor charging control circuit includes: a comparison circuit for comparing the voltage across the bootstrap capacitor with the reference voltage to generate a comparison output signal; a current comparison circuit for comparing a current of the inductor and a reference current level to generate a current comparison signal; and a latch for receiving the comparison output signal and the current comparison signal as a set and reset signal.

In one embodiment, the buck switching regulator further comprises a diode having an anode electrically connected to the voltage supply and a cathode electrically connected to the boost node.

In one embodiment, the buck switching regulator further comprises a power protection switch having one end electrically connected to the input terminal and another end electrically connected to the upper-gate switch, for protecting a power source electrically connected to the input terminal.

In one embodiment, the power protection switch includes a transistor electrically connected between the input terminal and the upper-gate switch, wherein the transistor includes a parasitic diode whose anode-cathode direction is for preventing a reverse current from flowing from the upper-gate switch toward the input terminal, or wherein the transistor includes a parasitic diode whose polarity is adjustable.

In one embodiment, the output terminal is electrically connected to a system load or a battery.

In one embodiment, the output terminal is electrically connected to the battery through a transistor, wherein the transistor includes a parasitic diode whose anode-cathode direction is for preventing a reverse current from flowing from the output terminal toward the battery, or wherein the transistor includes a parasitic diode whose polarity is adjustable.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a conventional buck switching regulator.

FIG. 2 explains how the conventional buck switching regulator wastes power.

FIG. 3 shows a schematic diagram of a buck switch regulator according to a first embodiment of the present invention.

FIG. 4 shows an embodiment of the bootstrap capacitor charging control circuit.

FIG. 5 shows another embodiment of the bootstrap capacitor charging control circuit.

FIG. 6 is a schematic diagram showing that the present invention, as compared with the conventional buck switching regulator, has improved power utilization efficiency.

FIGS. 7A and 7B show embodiments of the power protection switch.

FIGS. 8A-8C are several embodiments showing how the output terminal is electrically connected to a system load or a battery according to the present invention.

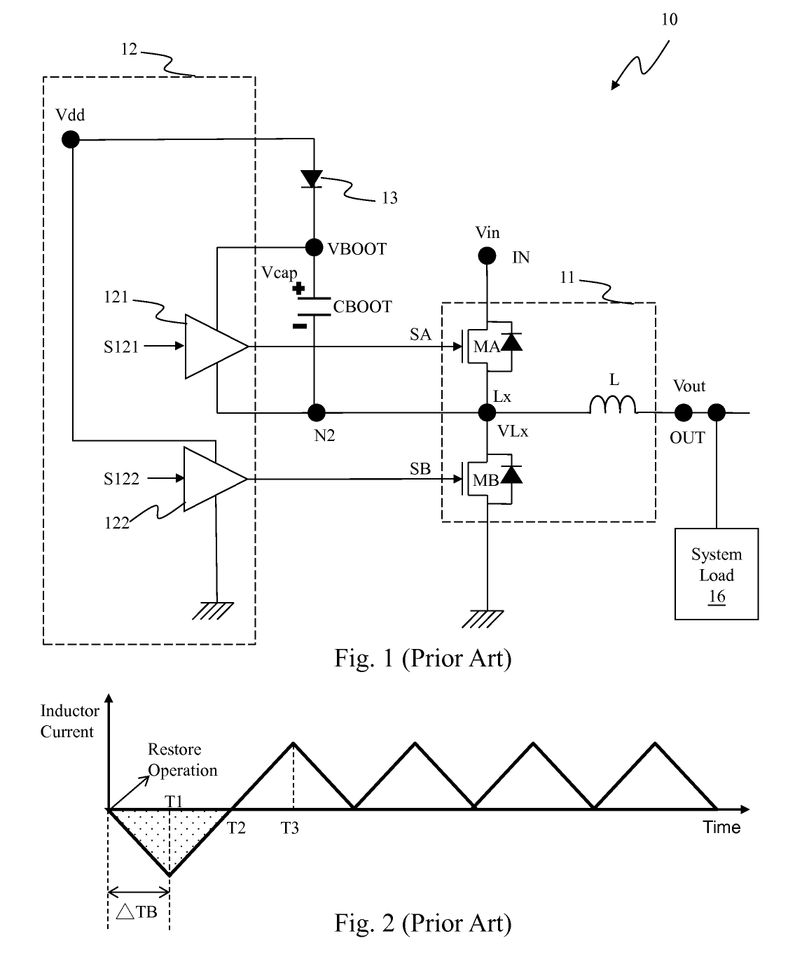

### DESCRIPTION OF THE PREFERRED EMBODIMENTS

The above and other technical details, features and effects of the present invention will be will be better understood with regard to the detailed description of the embodiments below, with reference to the drawings. In the description, the words relate to directions such as “on”, “below”, “left”, “right”, “forward”, “backward”, etc. are used to illustrate relative orientations in the drawings and should not be considered as limiting in any way. The drawings as referred to throughout the description of the present invention are for illustration only, to show the interrelations between the apparatus and the devices, but not drawn according to actual scale.

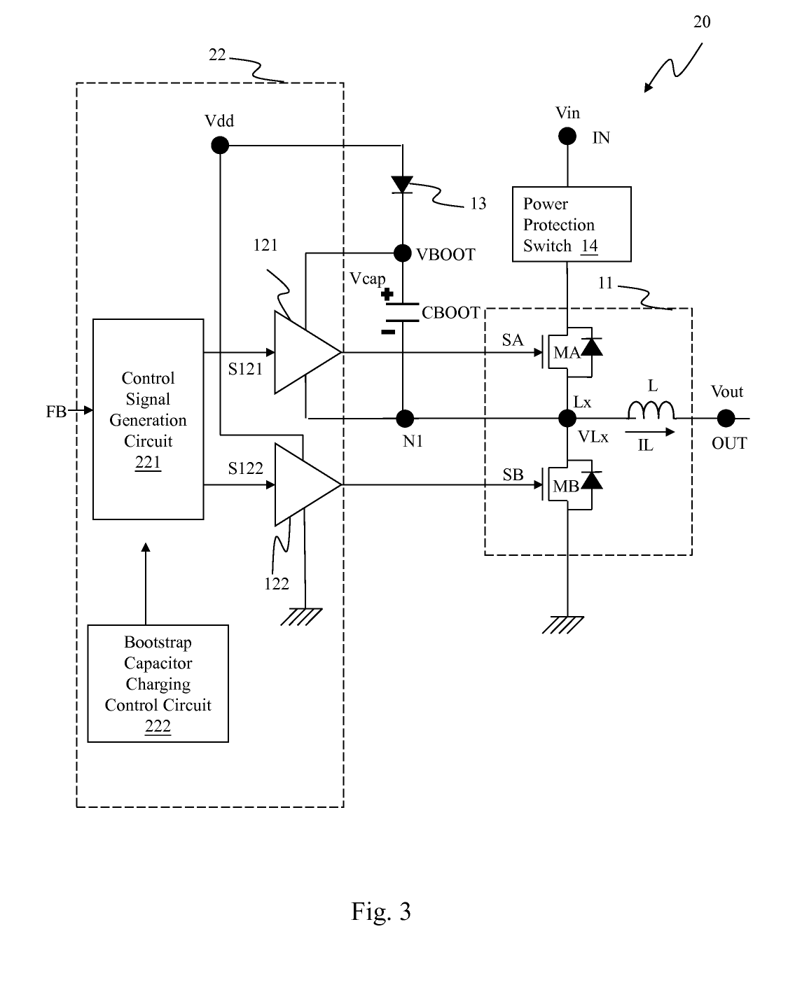

Please refer to FIG. 3, which shows a schematic diagram of a buck switch regulator according to a first embodiment of the present invention. The buck switch regulator 20 of this embodiment comprises a power stage 11, a driver circuit 22 and a bootstrap capacitor CBOOT. In addition, the buck switch regulator 20 can optionally (not necessarily required) comprise a diode 13 and a power protection switch 14. The power stage 11 of the buck switch regulator 20 comprises an upper-gate switch MA, a lower-gate switch MB and an inductor L. The upper-gate switch MA, the lower-gate switch MB and the inductor L are electrically connected to a common switching node Lx and controlled by a driver circuit 22. In this embodiment, the upper-gate switch MA can be, for example but not limited to, an NMOS transistor while the lower-gate switch MB can be, for example but not limited to, an NMOS transistor or a PMOS transistor. Specifically, the upper-gate switch MA has one end electrically connected to an input terminal IN and another end electrically connected to the switching node Lx. The lower-gate switch MB has one end electrically connected to the switching node Lx and another end electrically connected to ground. The inductor L has one end electrically connected to the switching node Lx and the other end electrically connected to the output terminal OUT. The driver circuit 22 comprises an upper-gate driver circuit 121, a lower-gate driver circuit 122, a control signal generation circuit 221 and a bootstrap capacitor charging control circuit 222. The control signal generation circuit 221 generates a first operation signal S121 and a second operation signal 5122. The upper-gate driver circuit 121 and the lower-gate driver circuit 122 of the driver circuit 22 generate a first driving signal SA and a second driving signal SB according to the first operation signal S121 and the second operation signal 5122, respectively, to turn ON/OFF the upper-gate switch MA and the lower-gate switch MB, thus delivering power from the input terminal IN to the output terminal OUT. Under normal operation, the control signal generation circuit 221 generates the first operation signal S121 and the second operation signal 5122 according to, for example, a feedback signal FB, to determine the ON-time of the upper-gate switch MA and the lower-gate switch MB. The feedback signal FB can be, for example, a signal related to the output voltage Vout or a signal related to a current IL of the inductor L. When the voltage Vcap across the bootstrap capacitor CBOOT is insufficient and the bootstrap capacitor CBOOT requires to be charged, the control signal generation circuit 221 generates the first operation signal S121 and the second operation signal 5122 according to the output of the bootstrap capacitor charging control circuit 222.

In this embodiment, the output terminal OUT can be electrically connected to a system load (not shown) or a battery (not shown), to supply power thereto (examples as to how the output terminal OUT is electrically connected to a system load or a battery will be discussed later). A bootstrap capacitor CBOOT is electrically connected between a boost node VBOOT and a node N1 (i.e., between the boost node VBOOT and the switching node Lx) to provide a desired voltage difference between the gate and the source of the upper-gate switch MA. The voltage Vcap across the bootstrap capacitor CBOOT serves to provide an operational voltage to the upper-gate driver circuit 121. In this embodiment, the bootstrap capacitor CBOOT is disposed, for example but not limited to, outside the driver circuit 22. In another embodiment, the bootstrap capacitor CBOOT can be integrated inside the driver circuit 22. The circuit of this embodiment also comprises a diode 13 having an anode electrically connected to a voltage supply Vdd in the driver circuit 22 and a cathode electrically connected to the boost node VBOOT. The voltage supply Vdd can be obtained from, for example but not limited to, the input voltage Vin. The diode 13, as described above, serves to prevent a reverse current from flowing from the boost node VBOOT toward the voltage supply Vdd when the voltage at the boost node VBOOT is higher than the voltage supply Vdd, so that there will not be such reverse current which may damage the voltage supply Vdd.

How the present invention has better power utilization efficiency is explained below.

Please refer to FIGS. 3-6. When the system load (not shown) transits from stand-by (consuming no or little power) to normal operation, the buck switching regulator 20 is required to restore operation under the condition where the upper-gate switch MA and the lower-gate switch MB are OFF. However, the voltage Vcap across the bootstrap capacitor CBOOT is insufficient because the charges stored in the bootstrap capacitor CBOOT have dissipated, and the bootstrap capacitor CBOOT cannot provide the operational voltage required by the upper-gate driver circuit 121.

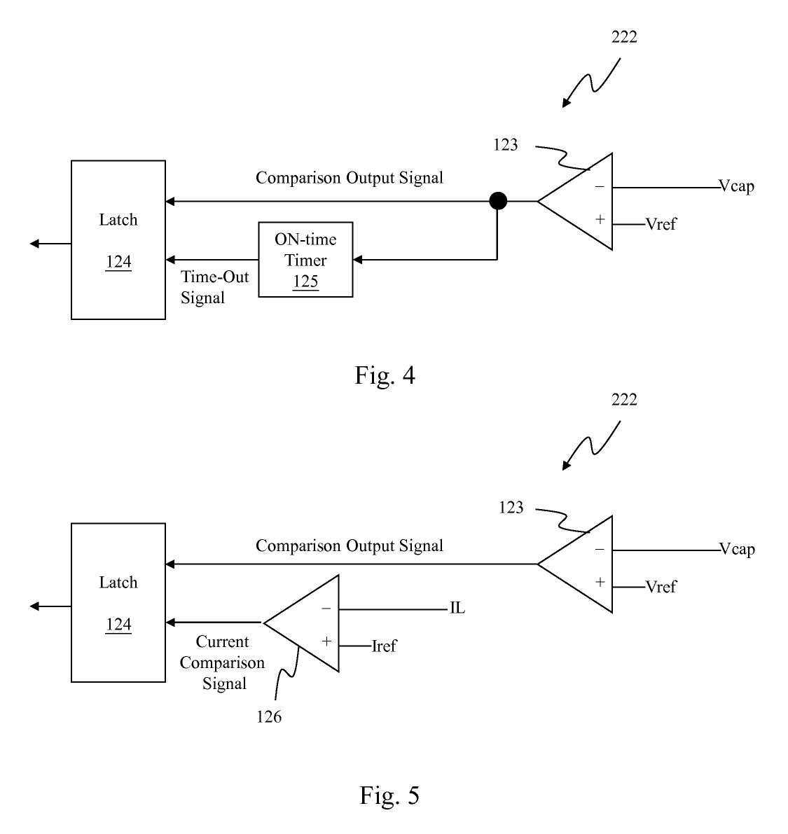

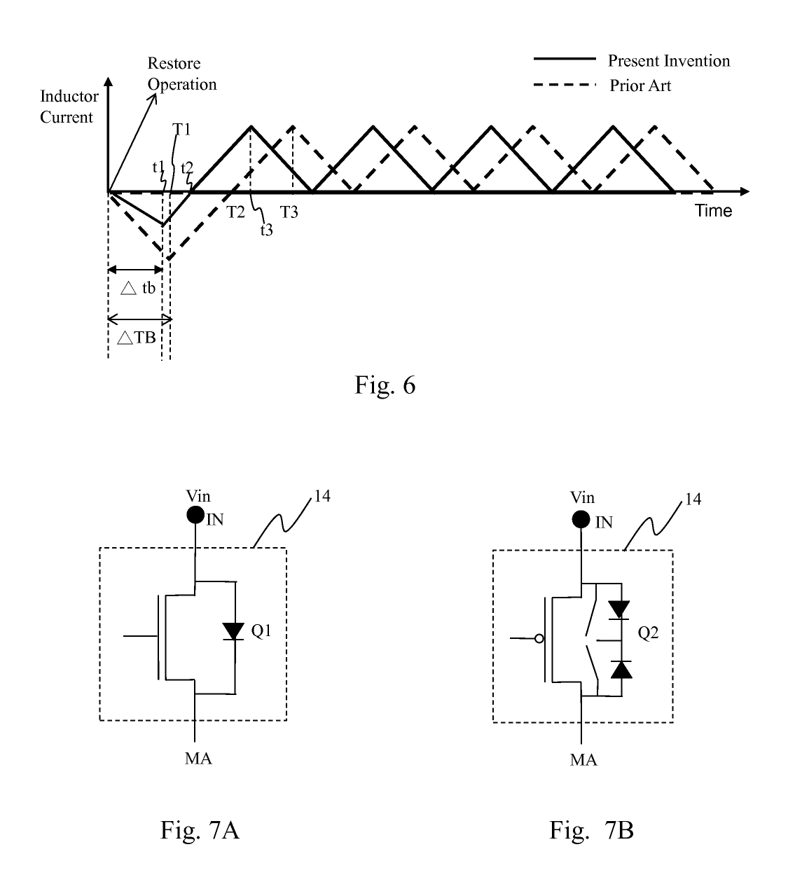

In the first embodiment shown in FIG. 4, the bootstrap capacitor charging control circuit 222 includes a comparison circuit 123, a latch 124 and an ON-time timer 125. The comparison circuit 123 determines whether the voltage Vcap across the bootstrap capacitor CBOOT is smaller than a reference voltage Vref, and generates a comparison output signal accordingly. The level of the reference voltage Vref can be determined according to the driving force required by the upper-gate switch MA (i.e., the voltage difference between high and low levels of the driving signal S121) and the desired response time for the buck switching regulator 20 to restore operation. If the voltage Vcap is smaller than the reference voltage Vref (which indicates that the bootstrap capacitor CBOOT is required to be charged), the comparison output signal generated by the comparison circuit 123 sets the output of the latch 124, so that the control signal generation circuit 221 turns ON the lower-gate switch MB and keeps the lower-gate switch MB conductive during the period from the time point “Restore Operation” to the time point t1 (as shown in FIG. 6). During this period, the upper-gate switch MA is OFF. When the lower-gate switch MB is ON, the voltage (VLx) at the switching node Lx is 0V because the switching node Lx is electrically connected to ground; thus, the voltage supply Vdd charges the bootstrap capacitor CBOOT through the diode 13. As a consequence, the difference between the voltage of the boost node VBOOT (Vcap+VLx) and the voltage of the switching node Lx (VLx) can reach Vcap to provide the operational voltage required by the upper-gate driver circuit 121.

Because a reverse current will flow in the direction from the output terminal OUT to the lower-gate switch MB during the period from the time point “Restore Operation” to the time point T1 (i.e., the period during which the lower-gate switch MB is ON), to avoid transmitting too much power from the output terminal OUT in the reverse direction, the present invention provides the following solutions. One solution is to control the ON-time of the lower-gate switch MB while the bootstrap capacitor CBOOT is being charged. Another solution is to detect the current IL of the inductor L while the bootstrap capacitor CBOOT is being charged. These solutions will be described below.

In the first embodiment shown in FIG. 4, the bootstrap capacitor charging control circuit 222 includes an ON-time timer 125, so that the ON-time of the lower-gate switch MB (the period from the time point “Restore Operation” to the time point t1, i.e., Δtb, as shown in FIG. 6) can be controlled while the bootstrap capacitor CBOOT is being charged. When the voltage Vcap becomes smaller than the reference voltage Vref such that the comparison output signal changes its level, starting from this time point, the ON-time timer 125 counts a predetermined period of time. Once the predetermined period of time (corresponding to Δtb) is reached, the ON-time timer 125 generates a time-out signal to reset the output of the latch 124. As a consequence, the control signal generation circuit 221 turns OFF the lower-gate switch MB.

When it is required to restore operation or it is required to charge the bootstrap capacitor CBOOT, on one hand, the present invention determines whether the voltage Vcap is smaller than the reference voltage Vref. When it is determined yes, the lower-gate switch MB is turned ON. On the other hand, the ON-time timer 125 of the present invention determines when the lower-gate switch MB should be turned OFF to avoid too much reverse power transmission from the output terminal OUT.

Next, please refer to FIG. 5 for the second solution. In the second embodiment shown in FIG. 5, the bootstrap capacitor charging control circuit 222 includes a comparison circuit 123, a latch 124 and a current comparison circuit 126. The comparison circuit 123 determines whether the voltage Vcap is smaller than a reference voltage Vref, and generates a comparison output signal accordingly. If the voltage Vcap is smaller than a reference voltage Vref (which indicates that the bootstrap capacitor CBOOT is required to be charged), the comparison output signal generated by the comparison circuit 123 sets the output of the latch 124, so that the control signal generation circuit 221 turns ON the lower-gate switch MB (which corresponds to the time point “Restore Operation” as shown in FIG. 6). ON the other hand, the current comparison circuit 126 determines whether the current IL of the inductor L reaches a reference current level Iref and generates a current comparison signal accordingly. The reference current level Iref can be determined according to design requirement. For example, the reference current level Iref can be determined according to one or more of the followings: (1) the charging requirement of the bootstrap capacitor CBOOT; (2) the inductance of the inductor L; and (3) limiting the inductor current such that there will not be too much current flowing in the reverse direction from the output terminal OUT (so that the buck switching regulator 20 will not perform a boost operation from the output terminal OUT to the input terminal IN). When the current comparison circuit 126 determines that the current IL of the inductor L reaches the reference current Iref, the current comparison signal generated by the current comparison circuit 126 resets the output of the latch 124. As a consequence, the control signal generation circuit 221 turns OFF the lower-gate switch MB.

Please refer to FIG. 6. After the lower-gate driver circuit 122 turns OFF the lower-gate switch MB (i.e., after the time point t1), the upper-gate switch MA can be successfully turned ON (because the difference between the voltage of the boost node VBOOT (Vcap+VLx) and the voltage of the switching node Lx (VLx) can reach Vcap to provide the operational voltage required by the upper-gate driver circuit 121). After the time point t2, the upper-gate switch MA and the lower-gate switch MB restore to the normal switching mode, whereby power is delivered from the input terminal IN to the output terminal OUT and supplied to the system load (not shown).

FIG. 6 shows the advantages of the present invention over the prior art. For the bootstrap capacitor CBOOT to be re-charged to restored operation of the buck switching regulator 20, the ON-time of the lower-gate switch MB only lasts for Δtb, so the reverse current flowing from the output terminal OUT to the lower-gate switch MB is smaller, as compared with the conventional buck switching regulator 10. Therefore, the power loss is less. In addition, because the reverse trend of the current IL is smaller, the present invention can restore to the normal switching mode in a much shorter time (Δtb which is the ON-time of the lower-gate switch MB of the present invention is shorter than ATB which is the ON-time of the lower-gate switch MB of the prior art. That is, the time point t2 is earlier than the time point T2). Therefore, the present invention is apparently superior to the prior art.

Please refer to 7A and 7B, which show two embodiments of the power protection switch 14. In certain applications of the present invention, a power protection switch 14 can be provided between the input terminal IN and the upper-gate switch MA (as shown in FIG. 3), and such power protection switch 14 is capable of preventing a reverse current from damaging the power source connected to the input terminal IN. The power protection switch 14 includes a transistor Q1 (as shown in FIG. 7A) or a transistor Q2 whose parasitic diode has a polarity which is adjustable (as shown in FIG. 7B). In the embodiment shown in FIG. 7A, the transistor Q1 has a parasitic diode having an anode electrically connected to the input terminal IN and a cathode electrically connected to the upper-gate switch MA. In other words, the polarity of the parasitic diode of the transistor Q1 is opposite to that of the parasitic diode of the upper-gate switch MA. Accordingly, when the voltage at the node connected to the upper-gate switch MA is higher than the input voltage Vin, the parasitic diode of the transistor Q1 is capable of preventing a reverse current from flowing in the direction from the upper-gate switch MA to the input terminal IN. Or, for another example, as shown in FIG. 7B, the parasitic diode of the transistor Q2 has a polarity which is adjustable. Therefore, when the voltage at the node connected to the upper-gate switch MA is higher than the input voltage Vin, the anode-cathode direction of the parasitic diode can be set to be opposite to the direction of the reverse current to prevent the reverse current from flowing in the undesired direction. And when the voltage at the upper-gate switch MA is lower than the input voltage Vin, if it is desired to prevent a forward current from flowing in the forward direction from the input terminal IN to the upper-gate switch MA (e.g., when it is desired to stop operating the buck switching regulator 20), the anode-cathode direction of the parasitic diode can be set to be opposite to the direction of the forward current. Thus, the power protection switch 14 can protect the power source or control the buck switching regulator 20.

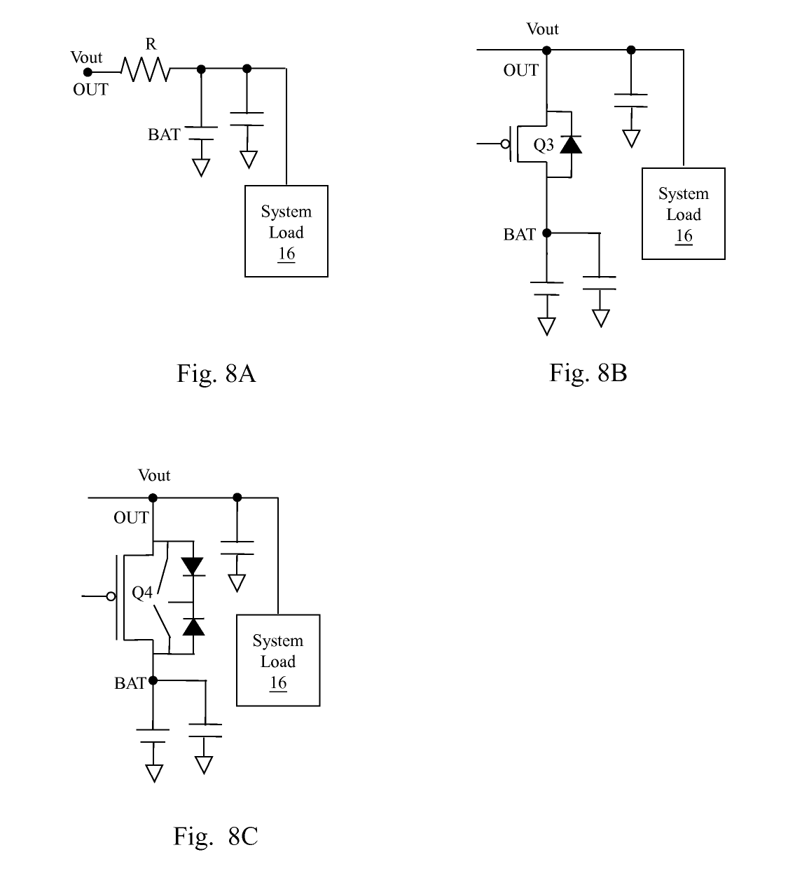

Please refer to 8A-8C, which are several embodiments showing how the output terminal is electrically connected to a system load or a battery according to the present invention. The output terminal OUT of the present invention can be electrically connected to a system load 16 or a battery BAT. The system load 16 can be, for example but not limited to, a handheld electronic device, etc. The battery BAT can be, for example but not limited to, a battery included in the electronic device, or an external battery such as a power bank. Please refer to the embodiment shown in FIG. 8A. The output terminal OUT can be electrically connected to the system load 16 or the battery BAT through a resistor R. In this embodiment, the output current can be detected by means of the resistor R, to generate a feedback signal for controlling the charging operation of the battery BAT. FIG. 8B shows another embodiment. The output terminal OUT can be electrically connected to the battery BAT through a transistor Q3. The battery BAT is charged from the output voltage Vout and the charging operation can be controlled by controlling the conduction of the transistor Q3. FIG. 8C shows yet another embodiment. The output terminal OUT can be electrically connected to the battery BAT through a transistor Q4 whose parasitic diode has a polarity which is adjustable. The charging operation of the battery BAT from the output voltage Vout can be controlled by controlling the conduction of the transistor Q4. When the output terminal OUT charges the battery BAT, the anode-cathode direction of the parasitic diode can be set to be opposite to the charging direction. And, when the bootstrap capacitor CBOOT needs to be charged, the anode of the parasitic diode can be directed toward the output terminal OUT while the cathode of the parasitic diode can be directed toward the battery BAT, thus preventing the battery BAT from discharging undesirably.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch. For another example, if the output signals of the control signal generation circuit 221 have a level which is sufficient to drive the upper-gate switch MA and the lower-gate switch MB, the upper-gate driver circuit 121 and the lower-gate driver circuit 122 can be omitted. For yet another example, the comparison circuit is not limited to a comparator. A Smith trigger changes its output state to high when its input is higher than a threshold and changes its output state to low when its input is lower than a threshold, so if the threshold is set to be equal to the reference voltage Vref, the Smith trigger can also act as a comparator circuit. For still another example, in the embodiments and the figures shown above, it should be noted that the comparison circuit 123 comparing the voltage Vcap with the reference voltage Vref and the current comparison circuit 126 comparing the current IL of the inductor L with the reference current Iref are for illustrative purpose. It is also practicable to compare a divided voltage of the voltage Vcap with a divided voltage of the reference voltage Vref, or to compare a proportional value of the current IL of the inductor L with a proportional value of the reference current Iref, which should be regarded as equivalents. For still another example, the “set” input terminal and the “reset” input terminal of the latch 124 are interchangeable, with corresponding amendments of the circuits processing these signals. In view of the foregoing, the spirit of the present invention should cover all such and other modifications and variations, which should be interpreted to fall within the scope of the following claims and their equivalents.

What is claimed is:

1. A buck switching regulator for converting an input voltage supplied from an input terminal to an output voltage at an output terminal, comprising:
a power stage, including:
an upper-gate switch having one end electrically connected to the input terminal and another end electrically connected to a switching node;
a lower-gate switch having one end electrically connected to the switching node and another end electrically connected to ground; and
an inductor having one end electrically connected to the switching node and another end electrically connected to the output terminal;
a bootstrap capacitor, which is electrically connected between a boost node and the switching node, wherein the boost node is electrically connected to a voltage supply; and
a driver circuit for controlling the operation of the upper-gate switch and the lower-gate switch, the driver circuit including:
a control signal generation circuit for generating a control signal to determine ON-time of the upper-gate switch and ON-time of the lower-gate switch; and
a bootstrap capacitor charging control circuit coupled to the control signal generation circuit, for determining whether a voltage across the bootstrap capacitor is smaller than a reference voltage and generating an output signal accordingly,
wherein when the voltage across the bootstrap capacitor is smaller than the reference voltage, the control signal generation circuit turns ON the lower-gate switch to charge the bootstrap capacitor from the voltage supply according to the output signal from the bootstrap capacitor charging control circuit.

2. The buck switching regulator of claim 1, wherein the bootstrap capacitor charging control circuit determines whether a time period during which the voltage across the bootstrap capacitor is smaller than the reference voltage has been over a predetermined period of time, and when it is determined yes, the output signal from the bootstrap capacitor charging control circuit causes the control signal generation circuit to turn Off the lower-gate switch.

3. The buck switching regulator of claim 1, wherein the bootstrap capacitor charging control circuit includes:
a comparison circuit for comparing the voltage across the bootstrap capacitor with the reference voltage to generate a comparison output signal;
an ON-time timer, wherein the ON-time timer starts to count a predetermined period of time when the comparison output signal indicates that the voltage across the bootstrap capacitor is smaller than the reference voltage, and when the predetermined period of time has been reached, the ON-time timer generates a time-out signal; and
a latch for receiving the comparison output signal and the time-out signal as a set signal and a reset signal.

4. The buck switching regulator of claim 1, wherein the bootstrap capacitor charging control circuit determines whether a current of the inductor reaches a reference current level, and when it is determined yes, the output signal from the bootstrap capacitor charging control circuit causes the control signal generation circuit to turn Off the lower-gate switch.

5. The buck switching regulator of claim 1, wherein the bootstrap capacitor charging control circuit includes:
a comparison circuit for comparing the voltage across the bootstrap capacitor with the reference voltage to generate a comparison output signal;
a current comparison circuit for comparing a current of the inductor and a reference current level to generate a current comparison signal; and
a latch for receiving the comparison output signal and the current comparison signal as a set and reset signal.

6. The buck switching regulator of claim 1, further comprising:
a diode having an anode electrically connected to the voltage supply and a cathode electrically connected to the boost node.

7. The buck switching regulator of claim 1, further comprising:
a power protection switch having one end electrically connected to the input terminal and another end electrically connected to the upper-gate switch, for protecting a power source electrically connected to the input terminal.

8. The buck switching regulator of claim 7, wherein the power protection switch includes a transistor electrically connected between the input terminal and the upper-gate switch, wherein the transistor includes a parasitic diode whose anode-cathode direction is for preventing a reverse current from flowing from the upper-gate switch toward the input terminal, or wherein the transistor includes a parasitic diode whose polarity is adjustable.

9. The buck switching regulator of claim 1, wherein the output terminal is electrically connected to a system load or a battery.

10. The buck switching regulator of claim 9, wherein the output terminal is electrically connected to the battery through a transistor, wherein the transistor includes a parasitic diode whose anode-cathode direction is for preventing a reverse current from flowing from the output terminal toward the battery, or wherein the transistor includes a parasitic diode whose polarity is adjustable.
